(19) United States
(12) Patent Application Publication
(10) Pub. No.: US 2009/0025533 A1
(43) Pub. Date: Jan. 29, 2009

(54) Quick connect and disconnect for drum pedals

(76) Inventors: Rusty Reens, Van Nuys, CA (US); Randy Reens, Burbank, CA (US)

Correspondence Address: ZUBER & TAILLIEU LLP, 10866 WILSHIRE BLVD., SUITE 300, LOS ANGELES, CA, 90024, US

(21) Appl. No.: 11/881,370

(22) Filed: Jul. 25, 2007

(51) Int. Cl. G10D 13/02

(52) U.S. Cl. 84/422.1

(57) ABSTRACT

Embodiments of the invention provide an apparatus for connecting drum pedals for a musical drum set. In one embodiment, an apparatus for connecting two drum pedals of a drum set comprises an outer tube having a proximal end and a distal end, the distal end of the outer tube being coupled with a first drum pedal; an inner rod having a proximal end and a distal end, the proximal end of the inner rod being slidably received through the proximal end of the outer tube, the distal end of the inner rod being coupled with a first drum beater; and a quick-release mechanism configured to releasably engage the outer tube with the inner rod. The quick-release mechanism includes a resilient engagement member that resiliently engages the outer tube with the inner rod and that is manually operable to disengage the outer tube from the inner rod.

### FIELD OF THE INVENTION

The invention relates generally to an apparatus for connecting two drum pedals of a drum and, more particularly, to an apparatus that provides quick and easy connection and adjustment of the connection between the drum pedals.

### BACKGROUND ART

Devices for connecting two drum pedals of a drum to enable a performer to play the bass drum simultaneously with two feet are known. U.S. Pat. No. 5,905,218 discloses one such device. The connection mechanism for connecting two drum pedals includes an inner rod slidably coupled with an outer tube. Bolts are inserted through holes in the outer tube and abut on a circumference of the inner rod to secure the connection between the inner rod and the outer tube. The connecting mechanism has certain disadvantages. When the inner rod is adjusted with respect to the outer tube, it may be separated from the outer tube because there is no means for preventing the inner rod from slipping away from the outer tube. Moreover, it is difficult for the inner rod to return to its original position during reassembly. Another problem is that the tip portion of the bolt abutting on the circumference of the inner rod may result in damage to the inner rod. U.S. Pat. No. 5,905,218 provides a resilient strip that is received in the recess of the outer tube and abuts the inner rod. A first end of the resilient strip has a protrusion integrally extending from one end thereof to be received in a through hole of the outer tube and a second end of the resilient strip is retained by a cutout of the inner rod. This mechanism can prevent damage to the inner rod and avoid separation of the inner rod from the outer tube.

U.S. Pat. No. 5,994,635 discloses a connecting mechanism including a hollow tube that receives inner rods at both ends. The first rod is linked to a first universal joint on the side of a first pedal and the second rod is linked to a second universal joint on the side of a second pedal. Curved elastic seating plates each include an inner surface which has an arcuate curvature that conforms to the outer shape of the universal joints to wrap around each universal joint. Flat elastic seating plates each have a planar shape that corresponds to the shape of the upper surface of the hollow tube. The elastic seating plates envelope the fixing screws that fasten the various connecting members, so that when the screws are released, they do not fall away. This also prevents idling of the screws.

In the above examples, the connecting mechanisms continue to use bolts or screws for connecting the various parts and joints between the two drum pedals, and employ additional structures for preventing damage to the inner rod, avoiding separation of the inner rod from the outer tube, and preventing accidental falling away or idling of the screws.

### SUMMARY OF THE INVENTION

There is a long-felt and unmet need of an effective and efficient apparatus for connecting the drum pedals of a drum set. Embodiments of the invention provide an apparatus for connecting drum pedals for a musical drum set. The apparatus includes a rod slidably received into a tube in a telescoping manner along the axial direction. The far end of the tube is connected to an operating shaft of a first pedal by a universal joint. The far end of the rod is connected to a first beater rotary shaft of a first drum beater by another universal joint. A second drum beater is disposed adjacent the first drum beater, and is coupled with a second pedal. The relative axial movement between the rod and the tube allows the distance between the pedals to be adjusted. An engagement member is provided to fix the rod and the tube in place when the desired distance is achieved. To facilitate easy and quick adjustment and setup of the apparatus for connecting the drum pedals, the engagement member is a quick-release engagement member. In a preferred embodiment, the rod includes notches spaced along the axial direction, and the quick-release engagement member releasably engages the notches to provide easy and quick adjustment of the distance between the pedals and engagement of the rod and the tube. In addition, the first universal joint is preferably coupled with the operating shaft of the first pedal by a quick-release coupling member, and the second universal joint is preferably coupled with the first beater rotary shaft by another quick-release coupling member, so as to facilitate quick and easy connection between the connecting mechanism and the first pedal and first drum beater.

In accordance with an aspect of the present invention, an apparatus for connecting two drum pedals of a drum set comprises an outer tube having a proximal end and a distal end, the distal end of the outer tube being coupled with a first drum pedal; an inner rod having a proximal end and a distal end, the proximal end of the inner rod being slidably received through the proximal end of the outer tube, the distal end of the inner rod being coupled with a first drum beater; and a quick-release mechanism configured to releasably engage the outer tube with the inner rod. The quick-release mechanism includes a resilient engagement member that resiliently engages the outer tube with the inner rod and that is manually operable to disengage the outer tube from the inner rod.

In some embodiments, the inner rod includes a plurality of spaced notches, and the resilient engagement member is attached to the outer tube and spring-loaded to resiliently engage one of the notches on the inner rod. The resilient engagement member is disposed near the proximal end of the outer tube. A first quick-release member is configured to connect the distal end of the outer tube with an operating shaft of the first drum pedal that rotates by actuation of the first drum pedal. The first quick-release member includes a first resilient member that is configured to resiliently engage the distal end of the outer tube with the operating shaft of the first drum pedal. A first universal joint is connected to the distal end of the outer tube. The first resilient member of the first quick-release member is configured to resiliently engage the first universal joint with the operating shaft of the first drum pedal. A second quick-release member is configured to connect the distal end of the inner rod with a first rotary shaft for the first drum beater that rotates with the first drum beater. The second quick-release member includes a second resilient member that is configured to resiliently engage the distal end of the inner rod with the first rotary shaft. A second universal joint is connected to the distal end of the inner rod. The second resilient member of the second quick-release member is configured to resiliently engage the second universal joint with the first rotary shaft.

In specific embodiments, the apparatus further comprises a second outer tube having a proximal end and a distal end, the distal end of the second outer tube being coupled with a second drum pedal; a second inner rod having a proximal end and a distal end, the proximal end of the second inner rod being slidably received through the proximal end of the second outer tube, the distal end of the second inner rod being coupled with a second drum beater; and a second quick-release mechanism configured to releasably engage the second outer tube with the second inner rod. The second quick-release mechanism includes a second resilient engagement member that resiliently engages the second outer tube with the second inner rod and that is manually operable to disengage the second outer tube from the second inner rod. A third quick-release member is configured to connect the distal end of the second outer tube with an operating shaft of the second drum pedal that rotates by actuation of the second drum pedal. The third quick-release member includes a third resilient member that is configured to resiliently engage the distal end of the second outer tube with the operating shaft of the second drum pedal. A fourth quick-release member is configured to connect the distal end of the second inner rod with a second rotary shaft for the second drum beater that rotates with the second drum beater. The fourth quick-release member includes a fourth resilient member that is configured to resiliently engage the distal end of the second inner rod with the second rotary shaft.

In accordance with another aspect of the present invention, an apparatus for connecting two drum pedals of a drum set comprises an outer tube having a first end and a second end; a first inner rod having a proximal end and a distal end, the proximal end of the first inner rod being slidably received through the first end of the outer tube, the distal end of the first inner rod being coupled with a first drum pedal; and a second inner rod having a proximal end and a distal end, the proximal end of the second inner rod being slidably received through the second end of the outer tube, the distal end of the second inner rod being coupled with a first drum beater. A first quick-release mechanism is configured to releasably engage the outer tube with the first inner rod. The first quick-release mechanism includes a resilient engagement member that resiliently engages the outer tube with the first inner rod and that is manually operable to disengage the outer tube from the first inner rod. A second quick-release mechanism is configured to releasably engage the outer tube with the second inner rod. The second quick-release mechanism includes a resilient engagement member that resiliently engages the outer tube with the second inner rod and that is manually operable to disengage the outer tube from the second inner rod.

In some embodiments, the first inner rod includes a plurality of spaced notches, and the first resilient engagement member is attached to the outer tube and spring-loaded to resiliently engage one of the notches on the first inner rod. The first resilient engagement member is disposed near the first end of the outer tube. The second inner rod includes a plurality of spaced notches, and the second resilient engagement member is attached to the outer tube and spring-loaded to resiliently engage one of the notches on the second inner rod. The second resilient engagement member is disposed near the second end of the outer tube.

In specific embodiments, a first quick-release member is configured to connect the distal end of the first inner rod with an operating shaft of the first drum pedal that rotates by actuation of the first drum pedal. The first quick-release member includes a first resilient member that is configured to resiliently engage the distal end of the first inner rod with the operating shaft of the first drum pedal. A first universal joint is connected to the distal end of the first inner rod. The first resilient member of the first quick-release member is configured to resiliently engage the first universal joint with the operating shaft of the first drum pedal. A second quick-release member is configured to connect the distal end of the second inner rod with a first rotary shaft for the first drum beater that rotates with the first drum beater. The second quick-release member includes a second resilient member that is configured to resiliently engage the distal end of the second inner rod with the first rotary shaft. A second universal joint is connected to the distal end of the second inner rod. The second resilient member of the second quick-release member is configured to resiliently engage the second universal joint with the first rotary shaft.

In accordance with another aspect of the invention, an apparatus for connecting two drum pedals of a drum set comprises a plurality of links telescopingly coupled with each other to adjust a distance between a first end of the plurality of links and a second end of the plurality of links; a first universal joint connected to the first end of the plurality of links and being configured to be coupled with a first drum pedal; a second universal joint connected to the second end of the plurality of links and being configured to be coupled with a first drum beater; and at least one quick-release mechanism configured to releasably engage the plurality of links and to be manually operable to disengage the plurality of links.

In some embodiments, the plurality of links include one or more inner rods telescopingly coupled with an outer tube. A first quick-release member is configured to connect the first universal joint with an operating shaft of the first drum pedal that rotates by actuation of the first drum pedal. The first quick-release member includes a first resilient member that is configured to resiliently engage the first universal joint with the operating shaft of the first drum pedal. A second quick-release member is configured to connect the second universal joint with a first rotary shaft for the first drum beater that rotates with the first drum beater. The second quick-release member includes a second resilient member that is configured to resiliently engage the second universal joint with the first rotary shaft.

These and other aspects of the invention are described in further detail below and shown in the accompanying drawings.

### DESCRIPTION OF THE DRAWINGS

FIG. 1 is a perspective view of an apparatus for connecting two drum pedals of a drum in accordance with an embodiment of the present invention;

FIG. 2 is an exploded perspective view of the connection mechanism in the apparatus of FIG. 1;

FIG. 3 is a perspective views of an outer tube and an inner rod used in the connection mechanism of FIG. 2;

FIG. 4 is a front elevational view of an apparatus for connecting two drum pedals of a drum in accordance with another embodiment of the present invention

FIG. 5 is a front elevational view in partial cross-section of an apparatus for connecting two drum pedals of a drum in accordance with another embodiment of the present invention; and

FIG. 6 is a front elevational view of the connecting mechanism in the apparatus of FIG. 5.

### DETAILED DESCRIPTION OF PREFERRED EMBODIMENTS

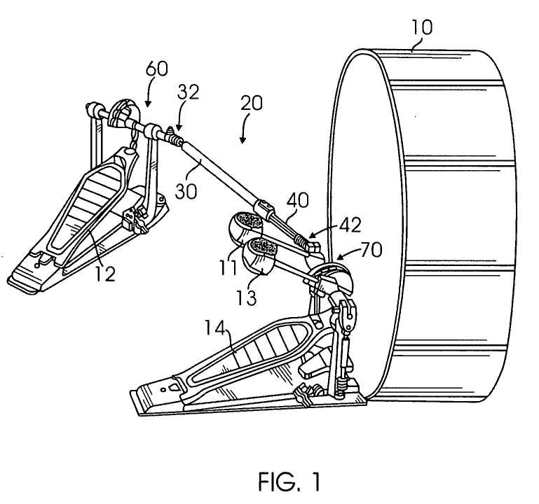

FIG. 1 is a perspective view showing an apparatus 20 for connecting first and second drum pedals 12, 14 of a drum 10 in accordance with an embodiment of the present invention. When the two drum pedals 12, 14 are operated by a user, two drumsticks or beaters 11, 13 pivotedly connected therewith will be driven (the first beater 11 being driven by the apparatus 20 connecting the first pedal 12 and the first beater 11) to hit the drum respectively or simultaneously. The two beaters 11, 13 are disposed adjacent to one another. The apparatus 20 includes an outer tube 30 and an inner rod 40 that are releasably connected with one another. The outer tube 30 has a far end or distal end 32 connected with the first drum pedal 12 via an operating shaft 60 that rotates by actuation of the first pedal 12. The inner rod 40 has a far end or distal end 42 connected with the first beater 11 via a first beater rotary shaft that rotates the first beater 11 by actuation of the first pedal 12 through the connecting apparatus 20. The second drum pedal 14 is connected to the second beater 13 via a second beater rotary shaft that rotates the second beater 13 by actuation of the second pedal 14.

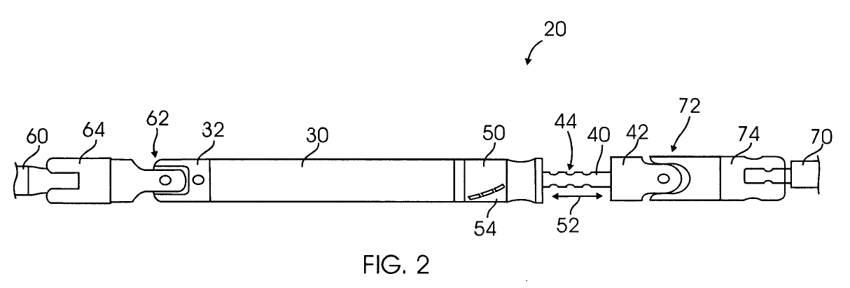

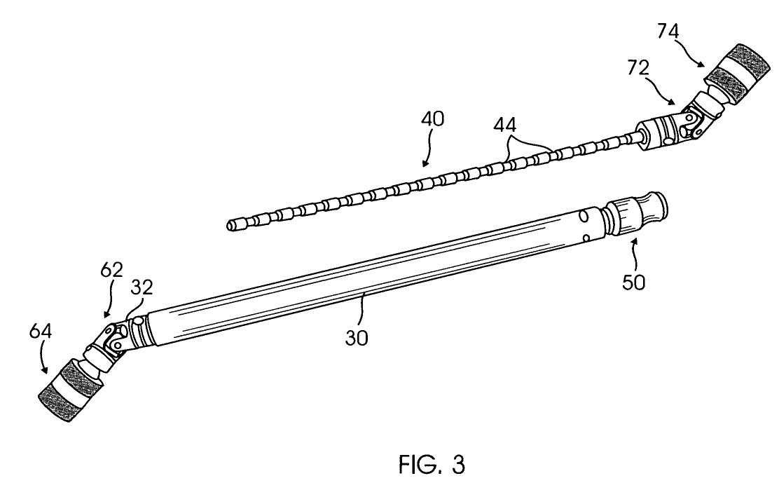

FIG. 2 is an exploded perspective view of the connection mechanism in the apparatus of FIG. 1 and FIG. 3 is perspective views of an outer tube and an inner rod used in the connection mechanism of FIG. 2. As shown in FIG. 2, the outer tube 30 and the inner rod 40 are releasably coupled by a quick connect/disconnect coupler or quick-release connection mechanism 50. The outer tube 30 and inner rod 40 serve as telescoping female and male members, respectively, that engage along an axial dimension in response to an engaging force that cause them to slide with respect to one another in the axial direction, as indicated by the double arrows 52. The quick-release mechanism 50 may have different configurations. In the embodiment shown, the inner rod 40 has a plurality of notches 44. The notches 44 may be about ¼ inch in width and adjacent notches 44 may be spaced about ½ inch apart. The outer tube 30 may include a spring-loaded engaging member 54 that is resiliently biased toward the inner rod 40 to engage one of the notches 44 to lock the inner rod 40 in position with respect to the outer tube 30. The engaging member 54 can be manually released to disengage the engaging member 54 from the notch 44 (e.g., by pressing a lever) to allow the inner rod 40 to slide out of the outer tube 30 or slide to a different position for engagement or locking between the engaging member 54 and another notch 44 on the inner rod 40. The relative axial movement between the rod 40 and the tube 30 allows the distance between the pedals 12, 14 to be adjusted. The engagement member 54 is provided to fix the rod 40 and the tube 30 in place when the desired distance is achieved. In this way, there are no problems with loose screws falling away or accidental disconnection between the inner rod 40 and the outer tube 30 and associated damage to the inner rod 40. The connection mechanism is quick and reliable, and allows the adjustment and setup of the coupling between the inner rod 40 and the outer tube 30 to be made easily by one person.

The far end or distal end 32 of the outer tube 30 is connected to the operating shaft 60 of the first pedal 12 by a first universal joint 62. The far end or distal end 42 of the inner rod 40 is connected to the first beater rotary shaft 70 by a second universal joint 72. The proximal end of the inner rod 40 is inserted into the proximal end of the outer tube 30. As a further way of facilitating the easy and quick setup of the apparatus 20 for connecting the drum pedals 12, a first quick-release member 64 is used to connect the distal end 32 of the outer tube 30 and the operating shaft 60, and a second quick-release member 74 is used to connect the distal end 42 of the inner rod 40 and the first beater rotary shaft 70. As seen in FIGS. 2 and 3, the first quick-release member 64 is disposed between the first universal joint 62 and the operating shaft 60, while the second quick-release member 74 is disposed between the second universal joint 72 and the first beater rotary shaft 70. The quick-release members 64, 74 allow the shafts 60, 70 to be quickly and easily connected to and disconnected from the outer tube 30 and the inner rod 40 of the connection mechanism, respectively. The quick-release members 64, 74 may each employ a spring-loaded engagement member with a notched structure or other suitable configurations.

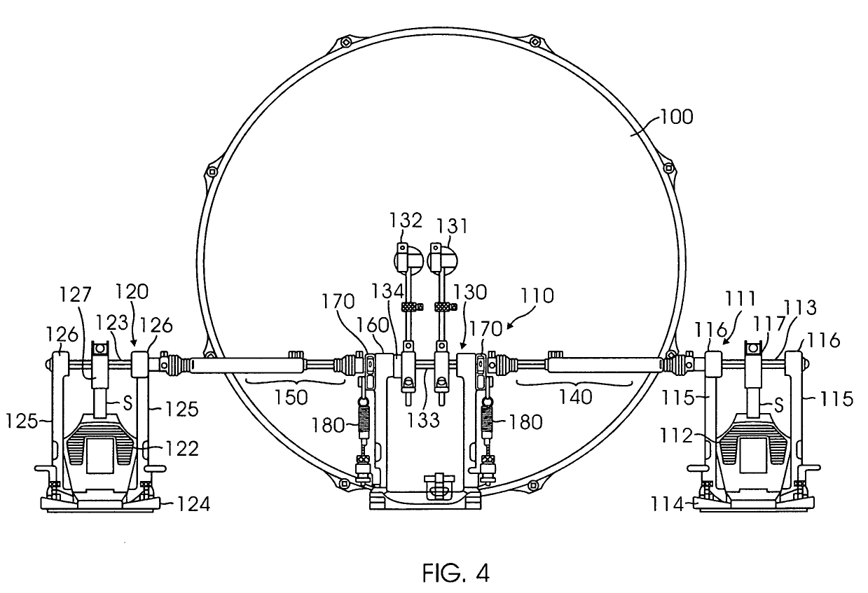

FIG. 4 shows another apparatus 110 for connecting two drum pedals of a drum 100. The dual drum pedal apparatus 110 includes a first pedal assembly 111, a second pedal assembly 120, and a beater assembly 130. As seen in FIG. 4, the first pedal assembly 111 and the second pedal assembly 120 are arranged at a proper angle from a bass drum 100 which faces the audience. As a result, the performer can perform with his body positioned toward the front of the stage.

The first pedal assembly 111 has a first operating shaft 113 which is rotated by a first pedal 112, and is linked to the beater assembly 130 through a first link 140. The first pedal assembly 111 includes supports 115 which are provided on both sides of a base 114. The first operating shaft 113 is journaled freely rotatably through a ball bearing 116 provided at the top of each support 115. Approximately at the center of the first operating shaft 113, there is an installation member 117 which rotates integrally with the first operating shaft 113. The outer periphery of the installation member 117 is wound with a strap S having an end that is fixed to the installation member 117. The other end of the strap S is linked to the tip of the first pedal 112. As the performer steps on the first pedal 112, the strap S is pulled down which rotates the installation member 117 and that rotates the first operating shaft 113.

The first link 140 is installed at one side of the beater assembly 130 and is linked to the first beater rotary shaft 133 of the beater assembly 130, and it links the first operating shaft 113 to the first beater rotary shaft 133. The first link 140 comprises the outer tube 30 and inner rod 40 of FIGS. 2 and 3 releasably connected as described above. The first and second universal joints 62, 72 allow the first pedal assembly 111 to be linked at a selected angle with the beater assembly 130.

The construction of the second pedal 120 assembly is the same as for the first pedal 111. The second pedal assembly 120 includes a second pedal 122, and a second operating shaft 123, which is linked to the beater assembly 130 through a second link 150. The second pedal assembly 120 includes a base 124, supports 125, bearings 126 at each support 125 for the second operating shaft 23, and an installation member 127 for a strap S. The structure of the second link 150 is the same as that of the first link 140 (i.e., the connection mechanism of FIGS. 2 and 3).

The beater assembly 130 includes a first beater 131 and a second beater 132. The beater assembly 130 is arranged approximately midway between the first pedal assembly 111 and the second pedal assembly 120. The first beater 131 is rotatably adjustably connected to the first beater rotary shaft 133, while the second beater 132 is rotatably adjustably connected to the second beater rotary shaft 134. The first beater rotary shaft 133 is linked to the first operating shaft 113 of the first pedal assembly 111 through the first link 140, and the second beater rotary shaft 134 is linked to the second operating shaft 123 of the second pedal assembly 120 through the second link 150. The first beater rotary shaft 133 and the second beater rotary shaft 134 are journaled freely rotatably by means of respective bearings at the tops of the supports that have been disposed on both sides of the beater assembly 130 and, at the same time, are linked integrally through a bearing part 160. The bearing part 160 is provided integrally within one end of the second beater rotary shaft 134, making it possible for the second beater rotary shaft 134 to rotate independently of the first beater rotary shaft 133. Since the first pedal 112 and second pedal 122 can thereby independently activate the first beater 131 and the second beater 132, the desired performance can be carried out by the performer using either the left or the right foot.

A cam 170 is positioned at each of the outer ends where the first beater rotary shaft 133 and the second beater rotary shaft 134 are not linked. Each cam 70 has a cam receiver hole through which the first beater rotary shaft 133 or the second beater rotary shaft 134 are inserted. Springs 180 are installed with respect to the cams 170. The tension of each spring 180 is adjusted for determining the feel of the first pedal 112 and the second pedal 122 when stepped on, and for determining the return speed of the first beater 131 and the second beater 132.

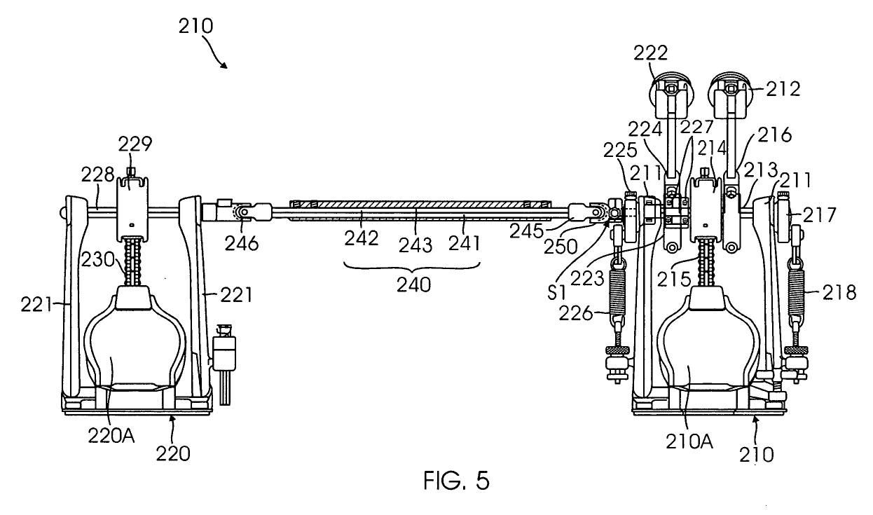

FIG. 5 shows another apparatus 210 for connecting two drum pedals of a drum. The apparatus 210 includes two drum head beaters 212 and 222, which are disposed adjacent one another and respectively operated by the right and left feet of a performer, for beating a single bass drum. Both beaters 212 and 222 are supported for swinging on the frame 211 of the first pedal 210. A rotary shaft 223 on which the second beater 222 is supported for rotation is provided on the frame 211 of the first pedal 210. The rotary shaft 213 for the first beater 212 is also provided on the frame 211. The rotary shaft 223 is connected with an operating shaft 228 that is rotatably operated by the second pedal 220 which is separate from the first pedal 210. A connecting mechanism 240 joins the shafts 213 and 228.

There is a first pedal plate 210A for the performer's right foot. The first pedal plate 210A is pivotally supported to the first pedal frame 211. An operating member 214, such as a sprocket or the like, is installed on the first beater rotary shaft 213. A chain 215, a belt, or the like connects the first pedal plate 210A and the operating member 214. There is an installation member 216 for the first beater 212, a cam 217 for the first beater rotary shaft 213, and a return spring 218 provided on the cam 217.

The second beater rotary shaft 223 for the second beater 222 is also provided on the first pedal 210 and its frame 211. An installation member 224 installs the second beater 222 on the second beater rotary shaft 223. There is a respective cam 225 for the second beater rotary shaft 223. A spring 226 provided on the cam 225 is for restoring its original orientation. A bearing 227 between the second beater rotary shaft 223 for the second beater 222 and the first beater rotary shaft 213 provides linked integration of the first beater rotary shaft 213 and the second beater rotary shaft 223 in a manner permitting each of them to be freely rotatable in a mutually independent manner.

The second pedal 220 includes a second pedal plate 220A for the performer's left foot, a second pedal frame 221 on which the plate 220A is rotatably supported, the operating shaft 228 which is rotatably operated by the second pedal plate 220A, an operating member 229, such as a sprocket or the like, for rotating the operating shaft 228 and a chain 230, belt, or the like for joining the second pedal plate 220A and the operating member 229.

The connecting mechanism 240 transmits the rotation of the operating shaft 228, which is caused by operation of the second pedal plate 220A of the second pedal 220, to the second beater rotary shaft 223 supported on the first pedal 210. The connecting mechanism 240 is joined with the operating shaft 228 at one end and with the second beater rotary shaft 223 at the other end through the respective universal joints 245 and 246 at both ends of the connecting mechanism 240, so that the first pedal 210 and the second pedal 220 may be freely arranged by a performer at any orientation with respect to each other, to be selected by the performer using the pedals.

The connecting mechanism 240 provides an adjustable structure which enables the distance and the relative orientations between the first pedal 210 and the second pedal 220 to be set for the convenience of the performer. The connecting mechanism 240 includes a first rod 241 linked to the universal joint 245 on the side of the first pedal 210 and a second rod 242 linked to the universal joint 246 on the side of the second pedal 220. The rods 241 and 242 are provided in a hollow tube 243 so as to slide freely therein.

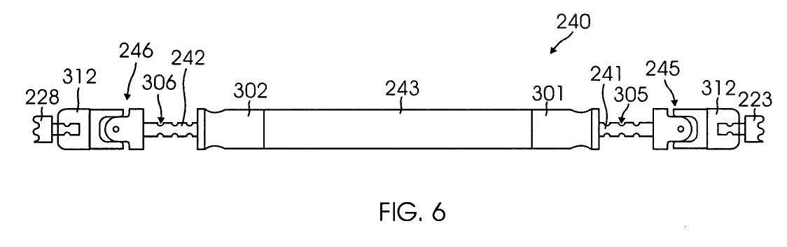

FIG. 6 is a front elevational view of the connecting mechanism 240 in the apparatus of FIG. 5. Quick connect/disconnect coupler or quick-release connection mechanisms 301, 302 are used to releasably connect the inner rods 241, 242, respectively, to the outer tube 243. The outer tube 243 serves as a telescoping female member, and the inner rods 241, 242 serve as telescoping male members, that engage along an axial dimension in response to an engaging force that cause them to slide with respect to one another in the axial direction. The quick-release mechanisms 301, 302 may have different configurations. In the embodiment shown, the inner rods 241, 242 each have a plurality of notches 305, 306. The outer tube 243 may include spring-loaded engaging members that are resiliently biased toward the inner rods 241, 242 to engage one of the notches 305, 306, respectively, to lock the inner rods 241, 242 in position with respect to the outer tube 243. The engaging members can be manually released to disengage the engaging member from the notches 305, 306 to allow the inner rods 241, 242 to slide out of the outer tube 243 or slide to a different position to engage or lock the rods in place, respectively. The relative axial movements between the inner rods 241, 242 and the tube 243 allow the distance between the pedals 210, 220 to be adjusted. The quick-release mechanisms 301, 302 fix the rods 241, 242 and the tube 243 in place, respectively, when the desired distance is achieved.

The far end or distal end of the first inner rod 241 is connected to the first beater rotary shaft 223 of the first pedal 210 by the first universal joint 245. The far end or distal end of the second inner rod 242 is connected to the second beater rotary shaft 228 of the second pedal 220 by the second universal joint 246. As a further way of facilitating the easy and quick setup of the apparatus 210 for connecting the drum pedals 210, 220, a first quick-release member 311 is used to connect the distal end of the first inner rod 241 and the first beater rotary shaft 223, and a second quick-release member 312 is used to connect the distal end of the second inner rod 242 and the second beater rotary shaft 228. As seen in FIG. 6, the first quick-release member 311 is disposed between the first universal joint 245 and the first beater rotary shaft 223, while the second quick-release member 312 is disposed between the second universal joint 246 and the second beater rotary shaft 228. The quick-release members 311, 312 allow the first and second beater rotary shafts 223, 228 to be quickly and easily connected to and disconnected from the first and second inner rods 241, 242 of the connection mechanism 240, respectively. The quick-release members 311, 312 may each employ a spring-loaded engagement member with a notch structure or other suitable configurations.

Although preferred embodiments of this invention have been described above with a certain degree of particularity, those skilled in the art could make numerous alterations to the disclosed embodiments without departing from the spirit or scope of this invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. An apparatus for connecting two drum pedals of a drum set, the apparatus comprising:
an outer tube having a proximal end and a distal end, the distal end of the outer tube being coupled with a first drum pedal;
an inner rod having a proximal end and a distal end, the proximal end of the inner rod being slidably received through the proximal end of the outer tube, the distal end of the inner rod being coupled with a first drum beater; and
a quick-release mechanism configured to releasably engage the outer tube with the inner rod, the quick-release mechanism including a resilient engagement member that resiliently engages the outer tube with the inner rod and that is manually operable to disengage the outer tube from the inner rod.

2. The apparatus of claim 1, wherein the inner rod includes a plurality of spaced notches, and the resilient engagement member is attached to the outer tube and spring-loaded to resiliently engage one of the notches on the inner rod.

3. The apparatus of claim 2, wherein the resilient engagement member is disposed near the proximal end of the outer tube.

4. The apparatus of claim 1, further comprising a first quick-release member configured to connect the distal end of the outer tube with an operating shaft of the first drum pedal that rotates by actuation of the first drum pedal.

5. The apparatus of claim 4, further comprising a first universal joint coupled between the distal end of the and the first quick release member, wherein the first quick release member is configured to resiliently engage the first universal joint with the operating shaft of the first drum pedal.

6. The apparatus of claim 1, further comprising:
a second quick-release member configured to removeably couple the distal end of the inner rod with a first rotary shaft for the first drum beater that rotates with the first drum beater.

7. The apparatus of claim 6, further comprising a second universal joint coupled between the distal end of the inner rod and the second quick release member, wherein the second quick-release member is configured to removeably couple and engage the second universal joint with the first rotary shaft of the first drum beater.

8. The apparatus of claim 1, further comprising:
a second outer tube having a proximal end and a distal end, the distal end of the second outer tube being coupled with a second drum pedal;
a second inner rod having a proximal end and a distal end, the proximal end of the second inner rod being slidably received through the proximal end of the second outer tube, the distal end of the second inner rod being coupled with a second drum beater; and
a second quick-release mechanism configured to releasably engage the second outer tube with the second inner rod, the second quick-release mechanism including a second resilient engagement member that resiliently engages the second outer tube with the second inner rod and that is manually operable to disengage the second outer tube from the second inner rod.

9. The apparatus of claim 8, further comprising:
a third quick-release member configured to removeably couple the distal end of the second outer tube with an operating shaft of the second drum pedal that rotates by actuation of the second drum pedal.

10. The apparatus of claim 8, further comprising:
a fourth quick-release member configured to connect the distal end of the second inner rod with a second rotary shaft for the second drum beater that rotates with the second drum beater.

11. An apparatus for connecting two drum pedals of a drum set, the apparatus comprising:
an outer tube having a first end and a second end;
a first inner rod having a proximal end and a distal end, the proximal end of the first inner rod being slidably received through the first end of the outer tube, the distal end of the first inner rod being coupled with a first drum pedal;
a second inner rod having a proximal end and a distal end, the proximal end of the second inner rod being slidably received through the second end of the outer tube, the distal end of the second inner rod being coupled with a first drum beater;
a first quick-release mechanism configured to releasably engage the outer tube with the first inner rod, the first quick-release mechanism including a resilient engagement member that resiliently engages the outer tube with the first inner rod and that is manually operable to disengage the outer tube from the first inner rod; and
a second quick-release mechanism configured to releasably engage the outer tube with the second inner rod, the second quick-release mechanism including a resilient engagement member that resiliently engages the outer tube with the second inner rod and that is manually operable to disengage the outer tube from the second inner rod.

12. The apparatus of claim 11, wherein the first inner rod includes a plurality of spaced notches, and the first resilient engagement member is attached to the outer tube and spring-loaded to resiliently engage one of the notches on the first inner rod.

13. The apparatus of claim 11, wherein the second inner rod includes a plurality of spaced notches, and the second resilient engagement member is attached to the outer tube and spring-loaded to resiliently engage one of the notches on the second inner rod.

14. The apparatus of claim 11, further comprising:
a first quick-release member configured to removeably couple the distal end of the first inner rod with an operating shaft of the first drum pedal that rotates by actuation of the first drum pedal.

15. The apparatus of claim 14, further comprising a first universal joint coupled between the distal end of the first inner rod and the first quick release member for removeably and resiliently coupling the operating shaft of the first drum pedal with the first inner rod.

16. The apparatus of claim 11, further comprising:
a second quick-release member configured to removeably couple the distal end of the second inner rod with a first rotary shaft for the first drum beater that rotates with the first drum beater.

17. The apparatus of claim 16, further comprising a second universal joint coupled between the distal end of the second inner rod and the second quick-release member to resiliently engage the second inner rod with the first rotary shaft for the first drum beater.

18. An apparatus for connecting two drum pedals of a drum set, the apparatus comprising:
a plurality of links removeably and telescopingly coupled with each other to adjust a distance between a first end of the plurality of links and a second end of the plurality of links;
a first universal joint connected to the first end of the plurality of links and being configured to be coupled with a first drum pedal;
a second universal joint connected to the second end of the plurality of links and being configured to be coupled with a first drum beater; and
at least one quick-release mechanism configured to releasably engage the plurality of links, said at least one quick-release mechanism being manually operable to disengage and separate the plurality of links.

19. The apparatus of claim 18, wherein the plurality of links include one or more inner rods telescopingly coupled with an outer tube.

20. The apparatus of claim 18, further comprising:
a first quick-release member configured to removeably couple the first universal joint with an operating shaft of the first drum pedal that rotates by actuation of the first drum pedal, the first quick-release member including a first resilient member that is configured to resiliently engage the first universal joint with the operating shaft of the first drum pedal.

21. The apparatus of claim 18, further comprising:
a second quick-release member configured to removeably couple the second universal joint with a first rotary shaft for the first drum beater that rotates with the first drum beater, the second quick-release member including a second resilient member that is configured to resiliently engage the second universal joint with the first rotary shaft.
